(19) United States
(12) Patent Application Publication
(10) Pub. No.: US 2024/0314158 A1
(43) Pub. Date: Sep. 19, 2024

(54) Artificial Intelligence-based Quantified Cyber Defense Control Model

(71) Applicant: Grant Bourzikas, O Fallon, IL (US)

(72) Inventor: Grant Bourzikas, O Fallon, IL (US)

(21) Appl. No.: 18/449,599

(22) Filed: Aug. 14, 2023

Related U.S. Application Data
(60) Provisional application No. 63/402,423, filed on Aug. 30, 2022.

(51) Int. Cl. H04L 9/40

(52) U.S. Cl. CPC H04L 63/1433; H04L 63/1441

(57) ABSTRACT

The present disclosure describes a system and a method that are configured to model probability of risk for future cybersecurity breach of a target by using a quantified cyber defense control (QCDC) model configured to receive data associated with cyber controls structure, control type control coverage, control strength, validation frequency, attack paths, threat intelligence, threat actors, attack tactics and techniques, and subject matter expertise control structure. The QCDC model includes a cyber defense & mitigation model (CDMM) configured to determine all available attacks that can be executed against the target by an attacker, and a cyber attack threat exposure model (CATE) configured to model a threat actor's previous attack pathways, current attack pathways, and future attack pathways against the target. The QCDC model is configured to generate an output indicative of the most likely attack against the target and associated mitigating defenses.

### RELATED APPLICATION

The present patent application claims the benefit of U.S. Provisional Patent Application No. 63/402,423 filed on Aug. 30, 2022, the entirety of which is incorporated herein by reference.

### FIELD

The present disclosure relates generally to the field of cybersecurity, and in particular to using artificial intelligence (AI) to model the probability of risk for future cybersecurity breach of a target.

### BACKGROUND

Cybersecurity is a serious issue for individuals, enterprises, and governments alike. Because nearly all computing devices are connected to the internet, the task of ensuring an organization's network and data remains safe is one of the biggest challenges of cybersecurity. Cybersecurity challenges come in many forms, such as ransomware, phishing attacks, malware attacks, denial-of-service attacks, and more. In the first half of 2020 alone, 36 billion records were exposed due to data breaches, according to a report generated by the firm RiskBased Security. In 2020, established organizations such as Marriott, MGM Resorts, Twitter, and Magellan Health all fell victim to cyber attacks.

### BRIEF DESCRIPTION OF THE DRAWINGS

FIG. 1 is a simplified block diagram of an embodiment of the Quantified Cyber Defense Control Model (QCDC) architecture;

FIG. 2 is a simplified block diagram of an embodiment of the Cyber Defense and Mitigation Model (CDMM) and Cyber Attack Threat Exposure (CATE) components of the Quantified Cyber Defense Control Model (QCDC) architecture;

FIG. 3 is an example plot of QCDC aggregate risk with current probability distribution;

FIG. 4 is an example plot of QCDC modeling the probability of a breach in future years from aggregate risk with Maximum Risk Reduction on Investment (MMROI) risk;

FIG. 5 is an example QCDC bipartite directed graph;

FIG. 6 is an example toy model using a source to sink graph representing three tactics, each with four techniques;

FIG. 7 is a diagram showing an example overview of threat actor scenarios that may vary based on data and/or SME input;

FIG. 8 is an example QCDC source to sink graph illustrating the Russian nation state threat actors;

FIG. 9 is an example plot of QCDC modeling the probability of a breach in future years from Russian and Lazarus nation state threat actors;

FIG. 10 is an example plot of QCDC modeling the probability of a breach from external, insider, and privileged insider attacker entry points in an organization;

FIG. 11 is an example plot of QCDC modeling the probability of a breach for data loss and operational resilience loss risk and compromise types;

FIG. 12 is example code for the formulation of neutral network model;

FIG. 13 is a graphical example of neural network threat actor prediction labels;

FIG. 14 is a table of probability of a breach over time for N number of simulations; and

FIGS. 15A and 15B are tables of QCDC loss of sensitive data and loss of operational resilience, respectively.

### DETAILED DESCRIPTION

An important aspect of a comprehensive cybersecurity strategy is to develop a thorough understanding of potential cybersecurity risks so that effective solutions for mitigation may be designed and implemented. The present disclosure describes a novel cybersecurity risk model that uses a digital twin and graph analysis to determine a cybersecurity risk score. This approach, termed Quantified Cyber Defense Control Model (QCDC), includes two main components: Cyber Defense and Mitigation Model (CDMM) 24 and Cyber Attack Threat Exposure (CATE) 26. The first, CDMM, is a machine learning artificial intelligence model that estimates the risk presented by different attackers, the risk of attackers' entry points, and how attackers' missions affect the probability of success. The second, CATE, is a model of attack pathways a threat actor has taken previously, is currently taking, and may take in the future to breach a company's system. The QCDC model is flexible, robust, and sufficiently complex to allow customization in a changing threat landscape while still ensuring the ability of such estimates to be consumed at an executive and operational view.

The proliferation of new security controls that have evolved alongside new attacks and new mitigating technologies have contributed to an organization's lack of ability to articulate its overall cybersecurity risk. Instead of a holistic assessment of risk, organizations have generally focused primarily on mitigating new possible avenues for attacks and selecting the best open source and commercial tools to prevent a breach. While current research has focused on machine learning algorithms like natural language processing to improve vulnerability assessment programs by reading vulnerability narratives, there has been no attempt to build an aggregate machine learning quantification of cybersecurity risk at an aggregate level.

Moreover, rather than addressing risk directly, companies regularly leverage cybersecurity maturity models that describe “what is” an organization's state rather than what is the current operating risk of an attacker exploit. A maturity model can quickly assess if companies utilize the processes and controls that are industry-accepted. In contrast, a quantified cybersecurity risk model evaluates the probability an attacker can bypass an organization's defense controls and breach the company. The reality is that the sheer complexity of the cybersecurity defense landscape is dizzying and contributes to the scale of the risk estimation problem. On average, organizations have, at their disposal, over forty security solutions to protect, detect, and respond to an attack.

Conventional cybersecurity defense schemes place reliance on compliance with industry standards instead of achieving an understanding of a company's aggregate cybersecurity risk profile. Simply installing and running software tools is not an effective nor sufficient cybersecurity risk mitigation strategy. Such perfunctory policies enable the cybersecurity decision-makers at each company to vouch for their cybersecurity approach by pointing to their adherence to industry standard practices and solutions, even in the face of failure.

A comprehensive method for quantifying cybersecurity risk grounded with actual threat actors and mitigating controls does not currently exist. The closest example is the Factor Analysis of Information Risk (FAIR) methodology, a quantitative risk analysis model developed by the FAIR Institute (fairinstitute.org) to help companies measure and evaluate the risk to make informed decisions. However, FAIR falls short in using threat intelligence, threat actor patterns, and mitigating control data.

The innovative QCDC model 10 described herein can be used to identify how attack patterns based on Threat Actor and Group Capabilities, Threat Actor Entry Point, and Threat Actor Mission Impact affect the overall risk profile based on the controls profile of an organization. The most notable contribution is the estimation of the Probability of a Breach over Time metric that presents a Forecasted Time of Expected Breach metric that can serve as an executive performance metric on the organization's health for Board members, Executives, Chief Information Security Officers (CISO), and Cybersecurity Leadership.

The QCDC model 10 also uses a digital twin 34 to generate data for supervised machine learning models. To demonstrate this, a neural network is trained to identify the most likely attacker from a partial list of identified attacks. This model is effectively sampling from the space of possible attack patterns and learning which possible attacks are reliability assignable to individual attackers.

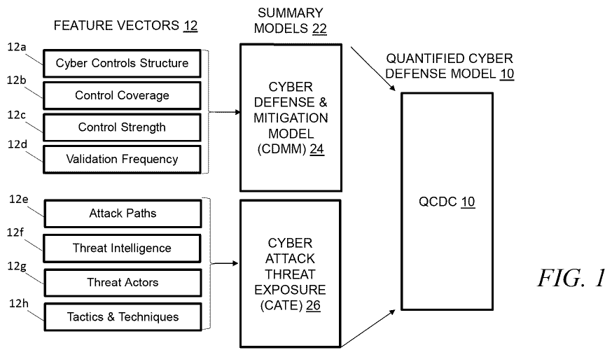

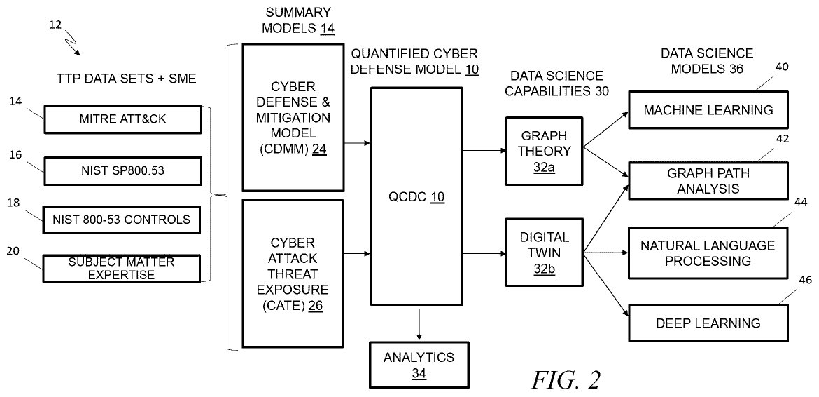

FIGS. 1 and 2 are block diagrams illustrating the system architecture of the QCDC (Quantified Cyber Defense Control) model 10. The QCDC model 10 is comprehensive as it includes two summary models 22: Cyber Defense and Mitigation Model (CDMM) 24 and Cyber Attack Threat Exposure (CATE) 26. CDMM 24 incorporates machine learning to estimate the risk presented by different attack actors, the risk of their entry points to a given target, and their probability of success. CATE 26 models attack pathway that a threat actor has taken previously, is currently taking, and may take in the future to breach a target's system. CDMM 24 incorporates feature vectors 12 in datasets 14-18, which include data related to cyber controls structure 12a, control coverage 12b, control strength 12c, and validation frequency 12d. CATE 26 also incorporates attack paths 12e, threat intelligence 12f, threat actors 12g, and tactics & techniques 12h specified in data sets 14-18. Feature vectors 12 also includes a subject matter expertise dataset 20.

Cyber control structure 12a refers to the organizational framework and architecture that encompass the various security controls, policies, procedures, technologies, and processes put in place to protect an organization's information systems, networks, data, and assets from cyber threats and risks. These controls are essential components of an organization's cybersecurity strategy and are designed to ensure the confidentiality, integrity, and availability of data and resources. Cybersecurity controls can be broadly categorized into three types: administrative, technical, and physical. Administrative controls encompass policies, procedures, and guidelines that define the framework and rules for the organization's cybersecurity practices. They include elements such as security policies, risk management processes, employee training and awareness programs, access control policies, incident response plans, and security awareness training. Administrative controls provide the foundation for an organization's cybersecurity governance. Technical controls involve the implementation of security measures through hardware, software, or firmware to protect systems and data. These controls are typically deployed to prevent unauthorized access, detect anomalies, and respond to security incidents. Examples of technical controls include firewalls, encryption, antivirus software, intrusion detection systems (IDS), intrusion prevention systems (IPS), multi-factor authentication (MFA), and secure coding practices. Physical controls are measures put in place to secure the physical access to critical infrastructure, equipment, and facilities. These controls involve physical barriers, surveillance systems, access control systems (e.g., biometric scanners, key cards), and environmental controls (e.g., temperature and humidity controls) to safeguard data centers, server rooms, and other sensitive areas. The cyber control structure is designed to manage and mitigate risks effectively, ensuring the confidentiality, integrity, and availability of critical information. Key components of a cyber control structure include:

Security Policies and Procedures: The foundation of a cyber control structure is established through well-defined security policies and procedures. These documents outline the organization's approach to cybersecurity, the responsibilities of personnel, acceptable use of resources, incident response protocols, and other essential security-related guidelines.

Security Controls: Cyber control structures consist of a range of security controls that act as protective measures to defend against various cyber threats. These controls can be technical (e.g., firewalls, encryption, access controls) or non-technical (e.g., security awareness training, background checks). They are carefully selected based on risk assessments and compliance requirements.

Risk Management: Effective risk management is an integral part of the cyber control structure. It involves identifying, assessing, and prioritizing cybersecurity risks, followed by implementing appropriate controls and continuously monitoring for new threats and vulnerabilities.

Incident Response and Recovery: The cyber control structure includes incident response plans and procedures to handle cybersecurity incidents effectively. It defines how the organization will detect, respond to, and recover from security breaches or data breaches.

Access Management: Access control mechanisms are a critical aspect of the cyber control structure. They ensure that only authorized individuals have access to sensitive information and resources, preventing unauthorized access and potential data breaches.

Security Awareness Training: Educating employees about cybersecurity risks and best practices is essential. Security awareness training is part of the cyber control structure to help staff recognize and respond to potential threats.

Continuous Monitoring: The cyber control structure involves ongoing monitoring and evaluation of security controls and systems to identify security gaps, anomalies, or suspicious activities. This allows for proactive detection and response to potential threats.

Compliance and Governance: The cyber control structure aligns with relevant industry standards, regulations, and best practices. Compliance with these requirements ensures that the organization meets cybersecurity obligations and reduces the risk of legal and financial consequences.

Third-Party Risk Management: Organizations often interact with third-party vendors and partners. The cyber control structure addresses the risks associated with third-party relationships and sets requirements for their security measures.

Control coverage 12b refers to the extent to which an organization's cybersecurity controls address the various threats, vulnerabilities, and risks faced by its information systems and assets. Control coverage 12b essentially assesses how well an organization's security measures align with the potential cybersecurity challenges it may encounter. Some key aspects of cyber control coverage include:

Security Controls: Cyber control coverage involves evaluating the implementation and effectiveness of security controls within an organization. Security controls are measures, policies, procedures, and technologies designed to safeguard information systems and data from unauthorized access, disclosure, alteration, and destruction. Examples of security controls include access controls, encryption, firewalls, intrusion detection systems, and security awareness training.

Risk Assessment: To achieve effective cyber control coverage, organizations conduct comprehensive risk assessments. These assessments help identify potential threats and vulnerabilities that could impact the confidentiality, integrity, and availability of information assets. By understanding the risks, organizations can prioritize and tailor their security controls accordingly.

Compliance and Standards: Cyber control coverage is often assessed against industry standards, best practices, and regulatory requirements. Compliance with standards like NIST SP 800-53, ISO/IEC 27001, CIS Controls, and industry-specific regulations ensures that an organization's security controls align with recognized benchmarks.

Vulnerability Management: An essential component of cyber control coverage is the organization's ability to effectively manage vulnerabilities. Regular vulnerability assessments and patch management processes are necessary to identify and remediate security weaknesses in systems and applications.

Incident Response: Having a robust incident response capability contributes to cyber control coverage. Organizations need to have well-defined incident response plans that outline the actions to be taken in the event of a cybersecurity incident. This ensures a timely and effective response to potential breaches.

Continuous Monitoring: Cyber control coverage involves continuous monitoring of security controls and systems to detect anomalies, security incidents, and potential weaknesses. Monitoring helps organizations proactively address emerging threats and improve the effectiveness of their security measures.

Third-Party Risk Management: Cyber control coverage extends beyond an organization's own infrastructure. It includes evaluating and managing the cybersecurity risks associated with third-party vendors and partners that have access to sensitive data or play a role in critical processes.

Control strength 12c refers to the effectiveness and robustness of the security controls and measures implemented within an organization to protect its information systems, data, and assets from cyber threats. Control strength 12c involves assessing the level of protection that these controls provide and their ability to withstand and mitigate potential cyberattacks or security incidents. Key aspects of cyber control strength include:

Effectiveness: The effectiveness of cyber controls is a measure of how well they achieve their intended security objectives. Strong controls are those that successfully prevent or detect cyber threats, reduce vulnerabilities, and safeguard sensitive information.

Resilience: Cyber control strength also involves the resilience of security measures. Resilient controls can adapt to changing threat landscapes, recover quickly from security incidents, and continue protecting the organization's assets even under duress.

Comprehensiveness: Strong cyber control structures are comprehensive and cover multiple layers of defense. This includes a combination of technical controls (e.g., firewalls, antivirus software, encryption) and non-technical controls (e.g., security policies, procedures, and employee training) working together to provide a layered defense approach.

Risk Reduction: The effectiveness of cyber controls is often measured by their impact on reducing cybersecurity risks. Strong controls should significantly lower the probability and impact of potential cyber threats and vulnerabilities.

Adaptability: As cyber threats evolve, cyber control strength relies on the ability of the controls to adapt and respond to emerging risks. Regular updates, patches, and adjustments are necessary to maintain the relevance and efficiency of security measures.

Consistency: Cyber control strength requires consistent implementation and enforcement of security policies and practices across the organization. This ensures that all systems, networks, and personnel adhere to the same security standards.

Monitoring and Evaluation: Strong cyber control structures include continuous monitoring and evaluation to identify weaknesses, potential gaps, and deviations from expected security levels. Regular assessments help improve the control's effectiveness and identify areas for improvement.

Compliance and Auditing: Cyber control strength involves ensuring that security controls align with industry standards, regulations, and best practices. Regular audits and compliance assessments help validate the effectiveness and adequacy of the controls.

Validation frequency 12d refers to how often an organization assesses, tests, and verifies the effectiveness of its security controls, processes, and overall cybersecurity measures. The validation frequency is an essential aspect of maintaining a strong and resilient cybersecurity posture, as it ensures that the organization's security measures remain up to date, effective, and capable of defending against evolving cyber threats.

Key aspects of validation frequency 12d include:

Security Assessments: Security assessments involve evaluating an organization's information systems, networks, and applications to identify vulnerabilities, weaknesses, and potential security gaps. The frequency of security assessments varies depending on factors such as the organization's risk profile, industry regulations, and the pace of technological changes. Some organizations conduct regular assessments annually, while others may perform them quarterly or even more frequently.

Penetration Testing: Penetration testing, also known as ethical hacking, involves simulating real-world cyberattacks to identify vulnerabilities and weaknesses in an organization's systems and applications. The frequency of penetration testing depends on the organization's risk tolerance and the rate of changes to its infrastructure and applications. High-risk environments or those with frequent updates may require more frequent penetration testing.

Vulnerability Scanning and Patching: Vulnerability scanning is the process of scanning systems and networks to identify known vulnerabilities. The frequency of vulnerability scanning should be determined by the organization's risk assessment, but it is common to conduct scans on a weekly or monthly basis. Patching, on the other hand, involves applying updates and security patches to fix identified vulnerabilities. Critical patches may require immediate deployment, while other patches can be scheduled based on their severity and impact.

Security Policy and Compliance Reviews: Reviewing security policies and ensuring compliance with industry standards and regulations is an essential part of maintaining cybersecurity. The frequency of policy reviews and compliance assessments may be driven by regulatory requirements, industry standards, or the organization's internal policies.

Incident Response Drills: Regular incident response drills and tabletop exercises help test the organization's ability to respond effectively to cybersecurity incidents. These exercises allow teams to practice their response plans, identify areas for improvement, and validate the efficacy of their incident response procedures.

User Training and Awareness: The frequency of cybersecurity training and awareness programs for employees should be consistent to reinforce safe cybersecurity practices. Ongoing training helps keep employees informed about the latest threats and best practices.

As shown in FIG. 2, the feature vectors 12 are specified in datasets 14-18 combined with subject matter expert knowledge 20. The datasets 14-18 are Techniques, Tactics, and Procedures (TTP) from at least three comprehensive sources: the MITRE ATT&CK (Adversarial Tactics, Techniques, and Common Knowledge) framework or knowledge base (attack.mitre.org) 14, Security and Privacy Controls for Information Systems and Organizations (NIST SP 800.53 published September 2020) 16, and NIST 800-53 Controls to MITRE ATT&CK Mappings from the Center for Threat Informed Defense 18. Techniques, Tactics, and Procedures (TTP) is a set of data that describes the behavior of an actor. A tactic is the highest-level description of this behavior, while techniques give a more detailed description of behavior in the context of a tactic. Procedures provides an even lower-level, highly detailed description in the context of a technique. It should be noted that one or more other data sets may be incorporated in future embodiments of the summary models 22 as needed.

The datasets 14-18 are combined and enhanced with subject matter expert knowledge 20 to form two enriched summary models 22: Cyber Defense and Mitigation Model (CDMM) 24 and Cyber Attack Threat Exposure (CATE) 26. These two models are combined to form QCDC 10. Together the QCDC 10 and the data science capabilities 30 (graph theory 32a and digital twin 32b), and analytics 34 form the novel aspects of this cybersecurity risk quantification model. The data science models 36 includes machine learning 40, graph path analysis 42, natural language processing 44, deep learning 46, and potentially other techniques. The CDMM and the CATE models 24 and 26 can be used independently. Company-specific information is used to enrich the CDMM and CATE models 24 and 26 to form the QCDC model 10 used for the risk analytics 34.

Machine learning 40 is a subfield of artificial intelligence (AI) that enables computers to automatically learn from training data sets and improve their performance on specific tasks without being explicitly programmed. Machine learning enables identifying patterns, making predictions, and generating insights from the training data, similar to the way humans learn from past experiences. Machine learning algorithms use a large volume of training data that consists of input examples paired with the corresponding correct outputs or labels. Machine learning may be supervised or unsupervised. In supervised learning, the training data is composed of features (input data) and labels (output data). The algorithm learns to map features to labels by finding patterns and relationships in the data. Machine learning involves selecting an appropriate model or algorithm that can best represent the underlying patterns in the data. Common types of machine learning models include linear regression, decision trees, support vector machines, and neural networks. During the training process, the algorithm iteratively adjusts its internal parameters based on the training data, so that it can make accurate predictions on new, unseen data.

Graph path analysis 42, also known as graph traversal or graph search, is a fundamental concept in graph theory and computer science. It involves systematically exploring a graph to find paths or routes between nodes (vertices) that satisfy specific criteria or constraints. The objective of graph path analysis is to identify the most efficient or optimal paths within a given graph. Depth-First Search (DFS) is a traversal algorithm that starts at a given node and explores as far as possible along each branch before backtracking. It is often implemented using recursion or a stack data structure. DFS is useful for exploring all paths in a graph but might not necessarily find the shortest path. Breadth-First Search (BFS) explores the graph level by level, starting from a given node. It visits all the neighbors of the current node before moving on to the next level. BFS is well-suited for finding the shortest path in an unweighted graph. Dijkstra's algorithm is used to find the shortest path in a weighted graph with non-negative edge weights. It is based on the principle of always selecting the next closest node until the destination is reached. The A* algorithm is an informed search algorithm that uses heuristics to guide the search towards the goal node efficiently. It combines the advantages of both BFS and Dijkstra's algorithm, making it useful for finding the shortest path in weighted graphs while considering the estimated cost to the goal.

Natural language processing (NLP) 44 is a branch of artificial intelligence and linguistics that focuses on the interaction between computers and human language. NLP aims to enable computers to understand, interpret, and generate human language in a way that is both meaningful and useful. NLP algorithms and models are used to process and analyze natural language data. NLP techniques include tokenization, parts-of-speech tagging, parsing, named entity recognition, sentiment analysis, machine translation, speech recognition, text generation, question answering, and language models. Tokenization is the process of breaking down a text into smaller units, typically words or sub-words (tokens) to enable subsequent analysis. Part-of-Speech Tagging (POS) tagging involves assigning grammatical labels (such as noun, verb, adjective, etc.) to each word in a sentence, helping computers understand the syntactic structure of the text. Parsing is the process of analyzing the grammatical structure of a sentence to determine the relationships between words and their syntactic roles. Named Entity Recognition (NER) is the task of identifying and classifying named entities in text, such as names of people, organizations, locations, dates, and more. Sentiment analysis, also known as opinion mining, involves determining the sentiment or emotion expressed in a piece of text. It is commonly used to analyze social media content, product reviews, and customer feedback. Machine translation aims to automatically translate text from one language to another, enabling communication across language barriers. Speech recognition is the process of converting spoken language into written text. This technology is used in virtual assistants and voice-controlled applications. Text generation involves creating coherent and meaningful text based on a given input or prompt. This includes chatbots, language models, and creative writing AI. Question answering systems aim to understand natural language questions and provide relevant answers. Language models are statistical models that predict the likelihood of a sequence of words occurring in a sentence. They are widely used in various NLP tasks, including machine translation and text generation.

Deep learning 46 is a subfield of machine learning and artificial intelligence that focuses on training artificial neural networks to learn and make intelligent decisions from large volumes of data. The word “deep” in deep learning refers to the use of multiple layers of interconnected artificial neurons to create a multidimensional neural network architecture. These networks are designed to mimic the way the human brain processes information. Deep learning is primarily based on artificial neural networks, which are computational models inspired by the structure and function of biological neurons in the human brain. Each artificial neuron processes input data, applies weights and biases, and produces an output signal that is then passed to other neurons. Deep learning models have multiple layers of neurons stacked on top of each other. These layers form a hierarchy of abstraction, allowing the network to learn complex patterns and features from raw data. Deep learning algorithms automatically learn to extract relevant features or representations from raw data. This feature learning process reduces the need for manual feature engineering, which was common in traditional machine learning methods. Deep learning models require a large amount of labeled training data to tune the millions of parameters within the neural network. Big data and powerful computing resources are often necessary for effective training. Training deep learning models involves an optimization process known as backpropagation. During backpropagation, the model adjusts its weights and biases to minimize the difference between its predicted output and the true output from the training data.

The MITRE ATT&CK dataset 14 is an open knowledge base and framework that provides a comprehensive and detailed catalog of cybersecurity threats, tactics, techniques, and procedures (TTPs) used to develop specific threat models and methodologies that leverages threat intelligence from the private sector, government, and the cybersecurity product and service community. The MITRE ATT&CK knowledge base 14 provides a common taxonomy for both offense and defense and has become a useful conceptual tool across many cybersecurity disciplines to convey threat intelligence, perform testing through red teaming or adversary emulation, and improve network and system defenses against intrusions.

Key components of MITRE ATT&CK include Tactics: ATT&CK organizes cyber adversary behavior into various high-level tactics that represent the objectives of an attacker during different stages of a cyberattack. Examples of tactics include Initial Access, Execution, Persistence, Privilege Escalation, Defense Evasion, Credential Access, Discovery, Lateral Movement, Collection, Exfiltration, and Impact. Each tactic is further broken down into specific techniques that describe the methods used by attackers to achieve their objectives. For example, techniques under the Execution tactic might include “Command-Line Interface,” “Exploitation for Client Execution,” and “Scheduled Task/Job.” MITRE ATT&CK also provides real-world examples of how threat actors have used specific techniques in documented cyberattacks. This includes information on the tools, malware, and procedures commonly associated with these techniques, which can help defenders recognize and respond to potential threats; and Matrices: ATT&CK Matrices are tables that align tactics and techniques with various threat actor groups. These matrices help to understand the specific behaviors and TTPs associated with different adversary groups and their motivations. The ATT&CK framework is continuously updated by MITRE as new threat intelligence and cyberattack information become available. Its structured approach to organizing and categorizing cyber threats has become a valuable resource for developing cybersecurity strategies, threat hunting, incident response, and assessing an organization's overall security posture.

The Security and Privacy Controls for Information Systems and Organizations dataset (NIST SP 800.53) 16 provides a comprehensive catalog of security and privacy controls to protect organizational operations and assets, individuals, other organizations, and the nation from a diverse set of threats and risks, including hostile attacks, human errors, natural disasters, structural failures, foreign intelligence entities, and privacy risks. These controls are flexible, customizable, and implemented as part of an organization-wide process to manage risk. These controls address diverse requirements derived from mission and business needs, laws, executive orders, directives, regulations, policies, standards, and guidelines. The consolidated control catalog addresses security and privacy from a functionality perspective (i.e., the strength of functions and mechanisms provided by the controls) and from an assurance perspective (i.e., the measure of confidence in the security or privacy capability provided by the controls). Addressing functionality and assurance helps to ensure that information technology products and the systems that rely on those products are sufficiently trustworthy.

Key features and aspects of NIST SP 800-53 include control families, where the publication is organized into control families that group related security and privacy controls together based on common objectives. Examples of control families include Access Control (AC), Audit and Accountability (AU), Configuration Management (CM), Identification and Authentication (IA), and System and Communications Protection (SC); Another feature is security and privacy controls defined within each control family. These controls provide detailed guidance on the technical, management, and operational measures that organizations should implement to secure their information systems effectively. NIST SP 800-53 provides a risk-based approach to security by categorizing information systems into three impact levels: low, moderate, and high. Each impact level corresponds to a set of security controls that are appropriate for the level of risk associated with the system's confidentiality, integrity, and availability. The publication emphasizes the importance of continuous monitoring of security controls and assessment of security posture to ensure ongoing protection against emerging threats and vulnerabilities. Organizations can tailor the set of controls based on their specific requirements, risk assessments, and operational environments. They can also supplement the baseline controls with additional measures, as needed.

The third dataset, NIST 800-53 Controls 18 to ATT&CK Mappings from the Center for Threat Informed Defense have been combined with NIST Special Publication 800-53, entitled “Security and Privacy Controls for Information Systems and Organizations,” to form a single control framework that provides detailed guidance on the technical, management, and operational measures that organizations should implement to protect their information systems and data from cybersecurity threats and risks. It contains over 6,300 individual mappings between NIST 800-53 and ATT&CK. These are foundational relationships, that in a single model, allow an organization to assess their security control coverage from NIST against real-world threats as described in the ATT&CK knowledge base.

The controls are organized into different families based on common security objectives, and they cover a wide range of security and privacy-related topics. The control families currently defined in NIST SP 800-53 Revision 5 are as follows:

Access Control (AC): Controls related to granting authorized individuals access to information systems and data while preventing access by unauthorized individuals.

Audit and Accountability (AU): Controls related to the creation, protection, and retention of audit records to enable the monitoring, analysis, investigation, and reporting of security events.

Awareness and Training (AT): Controls to ensure personnel are trained and aware of their cybersecurity roles and responsibilities.

Configuration Management (CM): Controls related to the establishment, implementation, and maintenance of a secure baseline configuration for information systems.

Identification and Authentication (IA): Controls related to uniquely identifying users, devices, and processes and verifying their claimed identities.

Incident Response (IR): Controls related to the organization's ability to detect, respond to, and recover from cybersecurity incidents.

Maintenance (MA): Controls related to the maintenance and management of information system components.

Media Protection (MP): Controls related to protecting information stored on physical and digital media.

Personnel Security (PS): Controls related to ensuring the trustworthiness and suitability of personnel who access information systems.

Physical and Environmental Protection (PE): Controls related to protecting physical facilities and the environment in which information systems operate.

Risk Assessment (RA): Controls related to identifying, assessing, and managing cybersecurity risks.

Security Assessment and Authorization (CA): Controls related to assessing and authorizing information systems to operate.

System and Communications Protection (SC): Controls related to the protection of information systems and communications from unauthorized access, tampering, and disruptions.

System and Information Integrity (SI): Controls related to protecting information systems from unauthorized access, tampering, and disruptions.

Supply Chain Risk Management (SR): Controls related to managing supply chain cybersecurity risks.

As shown in FIGS. 1 and 2, the three enriched and expanded datasets (knowledge bases) 14-18, together with subject matter expertise (SME) annotation 20, are used to generate the summary models 22 CDMM 24 and CATE 26 that are the primary components of QCDC 10. QCDC 10 is a cyber defense model that is based on key control components, such as cyber control structure, control type control coverage, control strength, control validation frequency, attack paths, threat intelligence, threat actors, attack tactics and techniques, and subject matter expertise control structure. The CDMM model 24 is a defense model generated using a SME control structure called the Cyber Defense and Mitigation Model (CDMM). The CDMM model 24 provides a capability to protect, detect, and respond to an attack that would prevent a breach built within the control structure. The CDMM model 24 is configured to determine all available controls that can be executed against a given target by an attacker. The CDMM model is a mapping between controls and attacks to assess the success probability of an attacker and the ability to prevent a successful attack. Control percentages from the CDMM model are applied to the controls for each control. The CDMM model is a machine learning artificial intelligence model that is based on cyber controls structure, control coverage, control strength, and validation frequency that measures the effectiveness of the control under an attack. The CDMM model is a specific controls assessments methodology that measures the effectiveness of a control or aggerated groups of controls that can determine the probability weighting of a successful or prevention of an attack. The CDMM model is configured to provide an aggregate view of all cybersecurity and privacy controls that mitigate attack paths and is a data-driven and quantified model. The CDMM model leverages aggregate controls and machine learning artificial intelligence to measure the success of an attack in aggregate when multiplied controls are required to prevent a successful attack. Statistics like standard deviation, variance, minimum, maximum, and mean control defense are used for distribution so analytics, machine learning, and artificial intelligence can be applied. The CDMM model leverages specific and aggregate controls and machine learning artificial intelligence that are mapped to tactics and technique in the attack threat exposure model (CATE) that are leveraged under attack scenarios within the CATE model.

CATE 26 is a model of the attack pathways a threat actor has previously taken, currently is taking, and potential attack paths to breach a target. While there are thousands of threat attackers and septillions different attack paths, it is essential to understand the pathways that attackers use to gain access, exploit systems, and breach organizations. While the data is substantial, connecting this data allows graph theory to be used to leverage past, current, and future threat intelligence for threat actors and attacks. The CATE model 26 represents a comprehensive understanding of all the attack pathways a threat actor has previously taken, currently is taking, and potential attack paths to attack and breach a company. The CATE model calculates a series of steps in chronological order that an attacker must perform to successfully breach an organization. The CATE model creates risk attack pathways that focus on the risk of loss of operational capabilities, data exfiltration risk, and a full compromise. The CATE model has more than 150,697,496,742,912,000,000,000, 1.506E+22, septillion attack paths that can be used for attack scenario planning. The CATE model simulates attack paths for known attack threat actor and group capabilities for specific threat actors, unknown threat using attacker software, and groups of attacks. The CATE model simulates attack paths for known attack to determine the threat actors entry point including, but not limited to the Internet, an Insider, a Privileged Insider. The CATE model simulates attack paths for known attacks to determine a compromised assessment path that includes the fastest breach path, cumulate path, most common path, and a company's ability to defend itself by using its strongest control path. The CATE model uses natural language processing with clustering to capture a group of similar attackers, like Russian nation-state actors vs specific named actors.

The term attack paths refer to the various routes or sequences of actions that an attacker can take to compromise a target system or network. Attack paths illustrate the steps an attacker might follow, exploiting vulnerabilities and weaknesses in the organization's cybersecurity defenses to achieve their objectives. Attack paths can be quite complex and may involve multiple stages, each building upon the previous one. These paths can be linear or branched, depending on the attacker's tactics, techniques, and goals. By understanding potential attack paths, cybersecurity professionals can better anticipate and mitigate threats, improving the organization's overall security posture. An example to illustrate an attack path includes the following:

Reconnaissance Phase: The attacker performs reconnaissance to gather information about the target, such as identifying potential targets, mapping the network topology, and researching employees' roles and responsibilities.

Phishing Attack: The attacker sends spear-phishing emails to employees, attempting to trick them into clicking on malicious links or opening infected attachments.

Initial Access: If an employee falls victim to the phishing attack and opens a malicious attachment, the attacker gains an initial foothold in the target's system.

Privilege Escalation: Once inside the network, the attacker tries to escalate their privileges to gain access to more sensitive resources and information.

Lateral Movement: With elevated privileges, the attacker moves laterally through the network, seeking valuable data or additional targets.

Data Exfiltration: The attacker locates and exfiltrates valuable data from the network, such as sensitive customer information or intellectual property.

Covering Tracks: To avoid detection, the attacker may attempt to cover their tracks by deleting logs or installing backdoors for future access.

Attack paths can differ significantly based on the attacker's motives and expertise, as well as the organization's security measures. As a result, it is crucial for cybersecurity teams to analyze potential attack paths through threat modeling, vulnerability assessments, penetration testing, and continuous monitoring of network activities. Understanding attack paths helps organizations prioritize security measures and focus on defense strategies that can disrupt or block potential attack paths. By identifying and securing vulnerable points along these paths, organizations can significantly reduce their risk of successful cyberattacks and protect critical assets and sensitive data.

Threat intelligence is information and knowledge about potential and actual cyber threats, including details about the tactics, techniques, and procedures (TTPs) used by threat actors to compromise systems, networks, and data. Threat intelligence is a valuable resource for organizations to proactively identify, understand, and mitigate cybersecurity risks and incidents. Key aspects of threat intelligence in cybersecurity include:

Data Collection: Threat intelligence involves the collection of data from various sources, including security researchers, cybersecurity vendors, government agencies, open-source intelligence (OSINT), dark web monitoring, and internal security logs. The data can include indicators of compromise (IOCs), malware signatures, known vulnerabilities, and reports on new and emerging threats.

Analysis and Context: Once data is collected, it needs to be analyzed and contextualized to be actionable. Cybersecurity analysts interpret the information to understand the intent, capabilities, and motives of threat actors and their tactics. This contextual analysis helps organizations prioritize and respond effectively to potential threats.

Indicators of Compromise (IOCs): Threat intelligence often includes IOCs, which are specific pieces of evidence that suggest malicious activity. IOCs can be IP addresses, domain names, hashes of malware files, patterns in network traffic, or any other artifacts associated with cyberattacks.

Tactics, Techniques, and Procedures (TTPs): Threat intelligence provides insight into the TTPs used by different threat actors. Understanding these tactics helps organizations recognize patterns and signatures of specific types of cyber threats, which, in turn, informs their defensive strategies.

Threat intelligence is an ongoing process in cybersecurity, as the threat landscape constantly evolves. Organizations need to continuously update their understanding of potential risks and emerging threats by regularly collecting and analyzing fresh threat intelligence. This proactive approach to cybersecurity helps organizations stay ahead of cyber threats and enhances their overall security posture.

Tactics and techniques refer to the strategies and methods employed by threat actors to compromise or attack systems, networks, and data. Tactics represent the high-level objectives or goals that threat actors aim to achieve during a cyberattack. Common tactics include gaining unauthorized access, stealing sensitive data, disrupting operations, spreading malware, and maintaining persistence within a compromised system. Tactics describe the “what” of the attack, outlining the ultimate objectives of the threat actor. Techniques, on the other hand, are the specific methods or procedures used by threat actors to achieve the tactical objectives. Techniques provide details on how the threat actor executes the attack or exploits vulnerabilities. For instance, specific techniques might involve using phishing emails to gain initial access, exploiting a software vulnerability to escalate privileges, using keyloggers to steal credentials, or using command-and-control servers to communicate with malware. Both tactics and techniques are critical components of threat intelligence.

The CATE model 26 uses techniques such as natural language processing with clustering to capture a group of similar attackers, like Russian threat actors vs specific named actors. Russian threat actors include state-sponsored groups whose activities are funded by the Russian government to gather intel, spread disinformation, or sow disruption, Russian APT groups, such as APT28 (Fancy Bear) and APT29 (Cozy Bear), have been linked to cyber espionage activities targeting governments, military, defense contractors, and critical infrastructure in various countries. Russian cybercriminals have also been involved in ransomware attacks, where ransom payments are demanded in exchange for decryption keys to regain access the victim's data. Russian threat actors have also been known to exploit weaknesses in the supply chains to infiltrate target organizations.

The CDMM component 24 may be used to generate or determine all the available attacks an attacker can execute, while the CATE component 26 provides the defensive capabilities a company has chosen to implement. The aggregation of CDMM 24 and CATE 26 results in the QCDC model 10 that provides the most common actions that attackers are likely to perform and the mitigating controls. Because of the enrichment from subject matter experts and the release of a digital twin 32b and graph networks 32a, together present a novel cybersecurity risk quantification modeling tool that is not previously available. The digital twin 32b combines the CATE and CDMM models together into the QCDC model in which machine learning 40 and artificial intelligence analysis models are leveraged to determine the most likely attacks against the target and the associated mitigating defenses. The digital twin 32b is used to simulate all CATE pathways using graph theory 32a. The digital twin 32b is used to simulate how attackers can exploit paths and controls to compromise an organization. The digital twin 32b can be used to simulate over a hundred million attacks and produce aggregate risk measurements within minutes. By leveraging graph theory 32a, all attack tactics and techniques are stored as nodes from the CATE model 26, whereas the weights for the nodes are derived from the CDMM model 24.

The digital twin 32b is a virtual representation of the target system and network, where the target's attributes and relationships are modeled as a graph. In graph theory, a graph consists of nodes (also called vertices) and edges (also called links or connections) that connect these nodes. Each node in the graph represents an individual component or entity, while the edges represent the relationships or interactions between these components. Digital twins in the context of graph theory leverage this graph structure to model the interconnectedness and behavior of a real-world system. By creating a digital twin of the target system and network, simulations of different scenarios (attackers, attackers, controls, etc.) can be run that provide valuable insights into the behavior, performance, and vulnerabilities of the physical system.

Combined together, the resultant QCDC model 10 allows for the threat and cybersecurity risk assessment of the three various formative models to address very specific questions in real time that address the aggregate cybersecurity risk by providing the Probability of Breach Over Time. The QCDC model 10 leverages all the interdependencies between threat actor attack patterns and mitigating controls built to leverage cumulative and probability distribution plots with over 500,000 random attack path samples. The QCDC model and technology have embedded subject matter expertise and constraints to provide a company with a view of the Probability of a Breach over Time in Years. Additionally, QCDC can simulate attack scenarios including Threat Actor and Group Capabilities, Threat Actor Entry Points in the Network, and specific Attacker Mission Impacts.

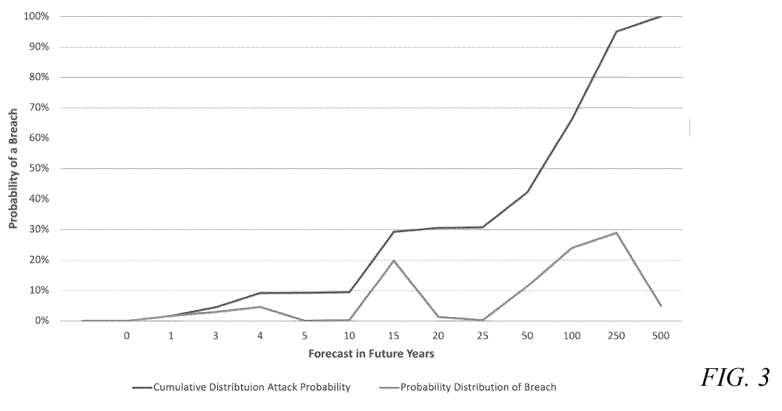

FIG. 3 is an example plot of the probability of a breach over time in years. There are two calculations in the QCDC model, the cumulative distribution that outlines the overall aggregate risk, and the probability distribution that is the point-in-time risk. In reviewing the QCDC model data, a company has minimal risk and there are key risk infliction points at 4 years, 15, years, and 50 years that need to be addressed, and apply the Maximum Risk Reduction on Investment (MMROI).

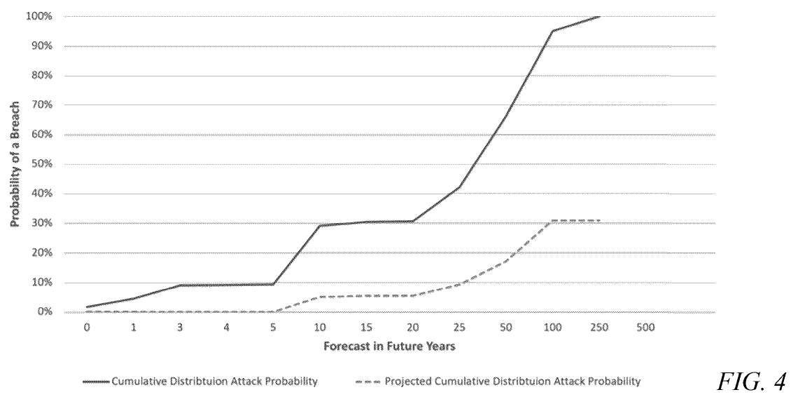

In FIG. 4, the example plot shows the aggregate cyber risk, but it also shows the Maximum Risk Reduction on Investment (MMROI). This is key component of the QCDC model because it removes subjective subject matter expertise by leveraging machine learning to optimize the cybersecurity controls that lower the overall cybersecurity risk and minimize the probability of a successful attack. The MMROI identifies company-specific controls and creates control-based strategy and plan to maximize the risk reduction on investment (MRROI). Leveraging graph theory is achieved by using cuts and changes in network flow through attacker paths. Within FIG. 4, the simulated controls issues there were identified with the cumulative distribution aggregate risk at 4 years, 15, years, and 50 years that needed to be addressed, have been addressed in the simulation of the new control structures “to be” put in place as outlined in the proposed cumulative distribution. Using a complex set of controls and attack paths leverages an enriched graphical network as the base data representation. The analysis involves analytics performed directly on the graphical structure and sampling from the graph to generate new training data that will be fed into a supervised machine learning problem.

The QCDC model 10 constructs the problem of cybersecurity exploitation as a sequence of bipartite directed graphs having a plurality of nodes representing attack techniques and tactics between a source node and a sink node. Each of the MITRE ATT&CK fourteen (14) high level tactics is a disjoint set. A pathway between all tactics represents a full breach. MITRE ATT&CK names each node within each set (Tactic) a Techniques. A full exploitation corresponds to an exploitation of all fourteen (14) techniques, one from each tactic to generate thirteen (13) bipartite matching. Attackers with different objectives require only a partial path. For example, an attacker that has insider privileged credentials (e.g., as an employee of the organization) uses a different entry point for the attacker to begin its attack. Regardless of the number of tactics required for an objective to be reached, the goal remains the same for the attacker: execute the mission and exploit at least one technique from each required tactic. The only variation is the number of disjoint sets required to be compromised. The existence of a path across the fourteen (14) disjoint sets can be modeled as a flow diagram or a source to sink model. A source node is fully connected to the first tactic, and a sink node is fully connected to the fourteen (14) tactics.

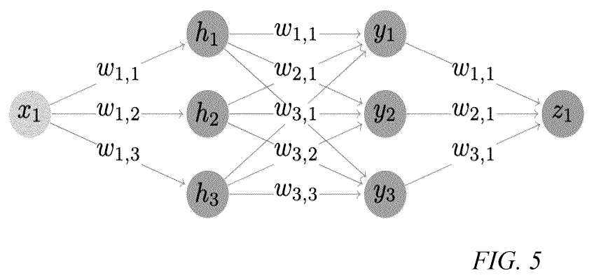

FIG. 5 is a diagrammatic representation of the graph and digital twin attack path structure. Each of the disjoint and independent set is a single node that is fully connected to each of the subsequent techniques in the disjoint set. The existence of an edge from tactic 1 to technique 1 means that technique 1 has been exploited, and technique 1 now may have an edge to tactic 2. By reducing the number of edges, it is easier to interpret the state of the graph. X₁ represents the source node and Z₁ represents the sink node. The nodes hₙ and yₙ are two sets of three nodes. The nodes W_{n,n} represent defense weight. The QCDC model network capability includes 150 septillion unique attack paths, 14 attack sets across 692 nodes, and 47,179 attack edges. The weights are determined by the CDMM model 24, and the paths between nodes are determined by the CATE model 26.

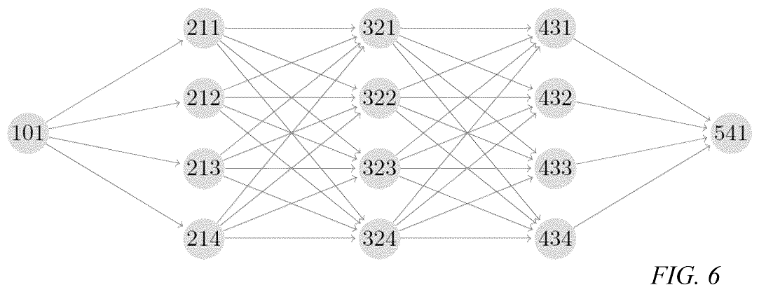

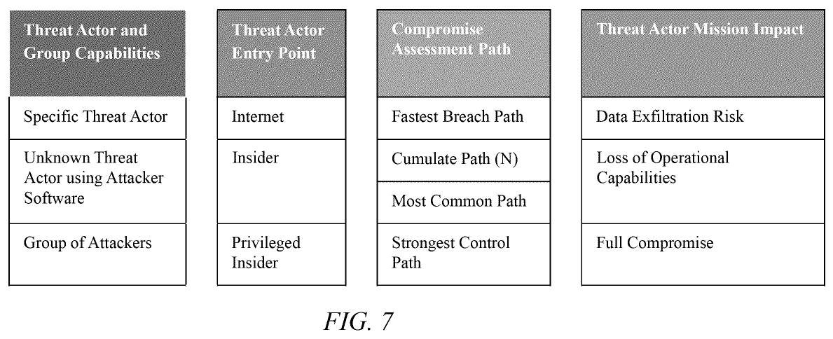

FIG. 6 is an example diagram of a toy model with three tactics (1,2,3), where each tactic has four techniques. Technique 11 (node labeled 211) corresponds to the first technique of the first tactic and technique 32 (node labeled 432) corresponds to the third tactic and its second technique. There are two bipartite matching, where the first is between tactic 1 and tactic 2, and the second between tactic 2 and tactic 3. Source node 01 (node labeled 101) is fully connected to all nodes (i.e., techniques) in tactic 1 and the sink node 41 (node labeled 541) is fully connected to all nodes (i.e., techniques) in tactic 3. The graph contains 43 unique pathways for a full breach when considering only a single node per tactic. The advantage of a source to sink model is that the edge weights may be augmented with additional information or context to compute the optimal path of attack through the network. To place a probability distribution on exploitation probability based on subject matter experience in this modeling framework, the weights on the outgoing edges from any particular technique with the 1-chosen probability are reset. With this formulation, Min-Cut Max-Flow theorem now corresponds to the tactic with the highest probability of a breach. Additionally, the minimal cost path corresponds to the easiest attacker path through the entire graph. The constructed graph is very large with 692 nodes and 43,179 edges. In total, there are more than 150 septillion unique attack paths from the source node to the sink node. This staggeringly large combination of unique technique combinations is contained within a very simple graph at the tactic level. To answer many of the simpler questions, a “greedy” approach may be used to choose a locally optimal transition from one tactic to the next and be certain that this solution is globally optimal.

To answer other questions, sampling from the fully 150 septillion unique paths may be required. For the simplest attacks, the process may be constructed as a Markov Chain using Markov Chain Monte Carlo methods (MCMC) to approximate the stable distribution of attack patterns. For the last class of problems, a digital twin may be constructed to generate large volumes of data with corresponding labels for training of supervised machine learning models. This may be expanded to a reinforcement learning framework given sufficient confidence exists on the plausibility of the priors constructed. By leveraging different locations of source to sink nodes, different threat actor scenarios can be used to calculate different attacker pathways resulting in different probabilities in the QCDC model, as seen in FIG. 6. For instance, a Ransomware Attack from a privileged insider has a different path than a data exfiltration from the Internet.

The distribution of attack patterns in the QCDC graph structure is augmented with historical context. For instance, there are septillion possible attack paths, and the empirical distribution for a particular attacker will be very different based on the path that is chosen. Since the number is still massively large, the empirical distribution is simulated by putting a weight on the probability of particular techniques being exploited by an attacker and form a probability distribution over the whole network. A digital twin is a simulation or representation of a real-world process used to run cost-effective simulations that can be used for evidence-based solutions. The digital twin simulation samples from the 150 septillion different possible attack pathway combinations. The digital twin technology includes all Threat Actor and Group Capabilities, Threat Actor Entry Points, and Threat Actor Mission Impact scenarios as seen in FIG. 6 that provides a diverse viewpoint of threat actor attacks. The QCDC model builds a simplified simulator of how threat actors, software, tactics, techniques, attack pathways, and attack mitigating controls to build a live ecosystem of a quantified cybersecurity risk model that can result in a Probability of a Breach by Future Years cybersecurity risk model. The digital twin technology allows for septillion data streams and attack flows to be analyzed and automatically analyzed in near real-time with fast and scalable performance with minimal code. The digital twin simulation builds a distribution of potential and most common plausible attacks observed and unobserved behaviors derived from historical threat actor threat intelligence or subject matter expertise and insights. The digital twin technology may be developed in Python using standard Python data libraries, which allow for extensibility from new data, and the creation of a full suite of analyses from simple analytics to machine learning or deep learning.

The graph analysis is used to address questions related to the threat actors and group capabilities, threat actor entry point, threat actor mission impact, and compromise assessment path. In each case the fundamental structure of available pathways on the graph changes about the choice of the threat actor, the entry point of the attacker, and the mission they want to impact. Therefore, the same mathematical result may be used to address different questions and reshape and build complex graph and digital twin networks.

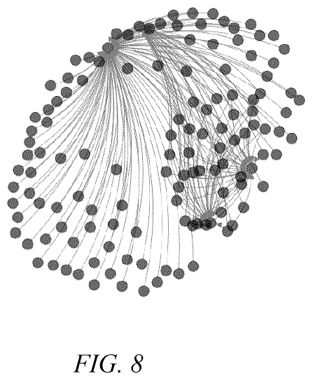

One of the first rules in protecting against the adversary is understanding and learning about the patterns in which they attack, which is a very strong use case for machine learning. The first step in understanding how threat actors can compromise an organization is to assess and determine what the threat actor has historically leveraged from patterns, tactics, and techniques, and determine if the traditional methods would be successful if they attacked. FIG. 8 is a diagram showing QCDC source to sink graph path modeling Russian Nation State threat actors. As seen in FIG. 8, leveraging the digital twin, the QCDC model groups the Russian State Actors and one of the most advanced threat actors in the world, Lazarus, and calculated the Probability of a Breach in Future Years using only three tactics. This was built using Natural Language Processing (NLP) and clustering to aggregate similar threat actors. In the case of the Ukraine-Russia Conflict, this is critical to understand what the impact could be from Russia Threat Actors on USA-based companies. Also, this model shows the capabilities of a group of threat actors but also shows how the model would work for one threat actor like Lazarus.

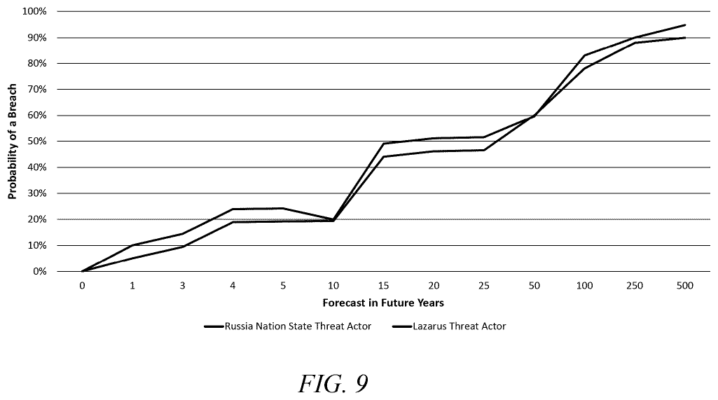

In either case of using sophisticated NLP with clustering or basic analytics, the power is the QCDC's ability to project the probability of a breach over time. In the illustration in FIG. 9 showing a comparison between Russia and Lazarus nation state threat actors, the results are similar and to be expected because of the capabilities of Lazarus, which is one of the most sophisticated threat actors in the world versus a group of threat actors to do not have the same capabilities. However, this is why the model was built because the risk of both of these is both high and a company would likely need to leverage the MMROI model to identify weak controls that need to be addressed.

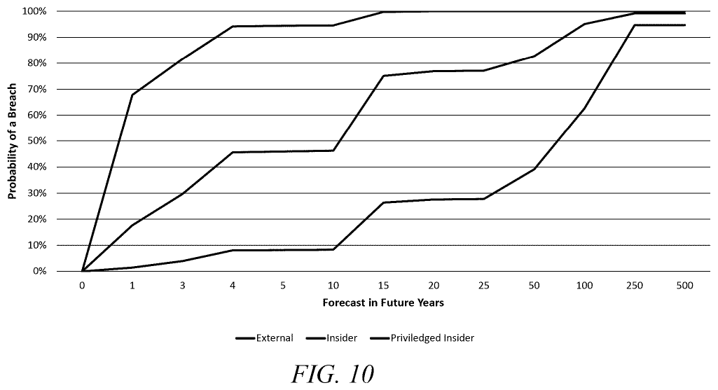

A fundamental approach to understanding and articulating cybersecurity risk is related to the entry point of the threat actor. This is often overlooked as many organizations assume a threat actor will attack from the Internet, which is more than often not the case. As attacks and threat actors evolve, so do attackers and the security defenses needed. Because threat actors have the same constraints as organizations face that are related to not having infinite amounts of people, time, and resources, attackers look for the easiest way to execute their mission. One way to do this is for attackers to gain access as an employee or obtain a role that enables status as an insider or a privileged credential insider, which is often the most cost-effective and more accessible path to bypass robust layers of security. As shown in FIG. 10, the QCDC model simulates the cumulative distribution of 500,000 attack paths and builds the probability of breach in future years. FIG. 10 shows that the risk is significantly increased in the first year from 1.5% from the Internet, 19% as an Insider, and 68% Privileged Credential insider.

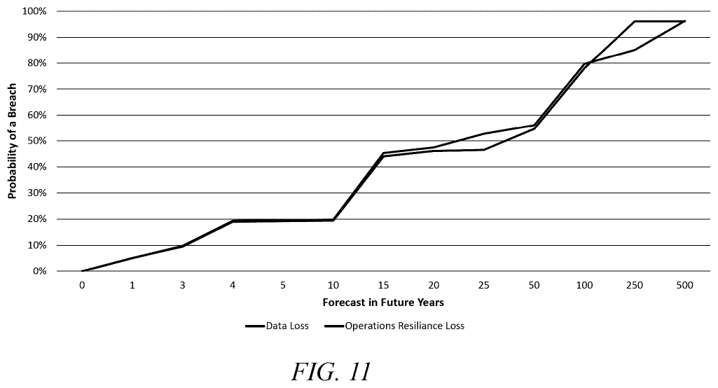

Another critical component to consider is the impact of the breach from the threat actor or the attacker executes a threat like a ransomware or intellectual property theft. Since not all threat attackers are equal, it is crucial to understand the intent of the threat actor so the model can simulate the appropriate attack. It is widely known that specific threat actors or nation-state actors specifically target intellectual property, while others launch malware like Stuxnet that target the loss of operations resilience (e.g. ransomware). Similar to the threat actor location, the threat actor mission impact is essential because specific pathways and attacks have to occur in order, and different types of attacks will create different attack and defense patterns. It is key to understand the impact the organization faces. Organizations need to focus on specific attacks that can help multiple scenarios like the loss of sensitive data and operational resilience. FIG. 11 shows QCDC risk and compromise type. The key to FIG. 11 is the ability to differentiate between the compromise resulting in a data loss versus a compromise of operational resilience loss like ransomware. These risks appear to be similar to the QCDC model, but the difference between the risks can be vastly different based on the company's control structure. Similar to the other QCDC illustrations, the graph in FIG. 11 is the result of a simulation of the cumulative distribution of 500,000 attack paths, and the probability of breach in years. Because the risk of the two compromise types, data loss and operational resilience loss, are very similar, the remediation leveraging the maximum risk reduction on investment (MRROI) as seen in FIG. 4 will be more holistic instead of very targeted so the focus can be an investment on controls to prevent a catastrophic impact to the company.

Each of the above QCDC models alters and builds a customized graph network within the digital twin, but other considerations can be used using traditional graph theory. While the digital twin is built to leverage a probability density function (PDF) for point-in-time risk and a CDF (cumulative distribution function) for aggregate risk graphs, alternative methods using machine learning and neural network algorithms may be incorporated to leverage future-based probabilistic models.

Another fundamental approach built into the QCDC model is understanding the compromise assessment path. Either the graph network or the digital twin can provide the same results. Because there are over 150 septillion attack paths, it is critical to understand what is being asked of the model to be able to allow it to present the best answer. So far, the research has leveraged the digital twin and has built cumulative distributions, but it is very critical to understand what is the fastest way an organization could be breached, how long would it take to get breached using the most common controls, and what is our strongest control mitigation.

To determine a compromise assessment path a threat actor would use, a 150 septillion attack path graph network is built according to graph theory to leverage Dijkstra's algorithm for Shortest Path which outlines the least controlled and resistance that will allow a threat actor to breach the organization (quickest attack path), an aggregation of the most used threat actor attacks (most common attack), and the strongest attack pathway and most difficult way to compromise an organization (strongest control attack path). The timeline for these three types of breaches are 96 days, 799 years, and 54,463 years, respectively. The shortest path, or weakest controls, will approximately take 96 days to breach the organization. This implies specific key controls are absent and or deprioritized. In comparison, leveraging the most common attacks and simulating the attacks under today's threat landscape will approximately take 799 years to breach the company. This implies that mitigating controls have been applied to the most common controls which are extremely good; however, it appears that controls have been overapplied and duplicated because the strongest control path take over 54,463 years to breach the organization. This analysis is critical because controls have been prioritized and remediated that are incorrect. After all, the organization should be focused on remediating the quickest or most common attack path to be breached versus applying more controls on pathways that are already protected. Additionally, reviewing the compromise path of the graph is a key aspect of understanding the shape and structure of the organization mitigating controls.

Threat actor attribution is one of the most discussed problems for CISOs. In the QCDC threat actor attribution model, the algorithm leverages known relationships between attackers and their preferred attack flow. This allows the QCDC model to be used as a digital twin to model and build complete or partial paths as attack patterns and ascribe them to an attacker. Sampling from this space allows us to build a distribution of partial attack patterns and their corresponding likely threat actors. A simplified model where there is an even probability for the attacker and the attacker's choice of attack flow may be used for this purpose. In the future, the model's accuracy can be enhanced by the inclusion of more complicated assumptions and knowledge of attacker profiles as new threat intelligence is automated. Ultimately these may come from more robust shared models across companies of attacker profiles or subject matter experts altering assumptions given company or time circumstances. Finally, additional information related to the particular construction of the networks and systems, for instance, can determine advanced control structures and determine the robustness of the model in specific circumstances. By simulating existing attacks or attackers, the QCDC model is configured to calculate the probability of a breach in years.

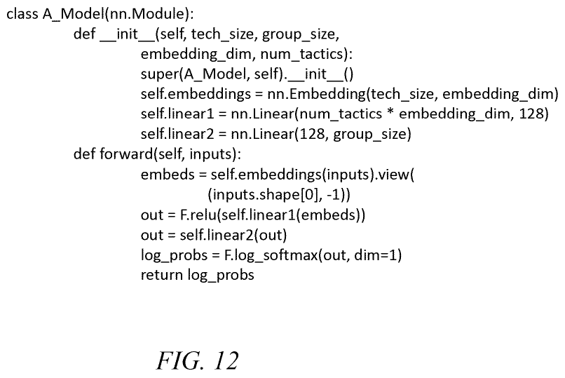

In the current threat actor inventory, 104 different threat actors exist, which are sampled 10,000 times to generate a 104,000 row matrix with 14 columns of corresponding tactics. A feed forward neural network model is trained using embedding to predict with of the 104 attackers is responsible for each of 104 k attack patterns. The first pass trained over 100 epochs, with batch size of 256. The code in FIG. 12 illustrates the formulation of the neural network code.

While the theoretical search space of the graph is large, the behavior used to model the attackers is confined to strict sub-regions. These behaviors are unique enough that analysis of attacks has leveraged, among other things, the pattern of behavior of attackers to ascribe responsibility for attacks. These presence or absence of utilization of sub-regions of the graph are telltale signs of responsibility. This makes attacker attribution easier than one might mathematically anticipate. Fortunately, deep learning techniques favor such a scenario, learning a lower dimensional representation of a higher dimensional object and in that sense, the results are extensions of other recent deep learning results.

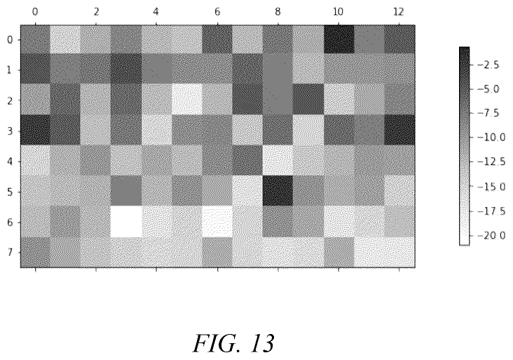

FIG. 13 is a plot that shows neural network threat actor prediction labels. As shown in FIG. 13, this matrix is the prediction of a specific attack in which the threat actor OilRig, in label 10, could execute and the QCDC predicted the accurate results.

The results are divided into specific model raw results from the QCDC and a narrative description of the novel contribution results. While reporting should lend to the graphics of probability of a breach over time, the power and flexibility of the QCDC model is the ability to quantify the cybersecurity risk in terms of probability of a breach over time. While the probability is fixed to the threat actor scenarios based on the subject matter expertise embedded in the digital twin and graph networks, time can be presented in any random number of N simulations.

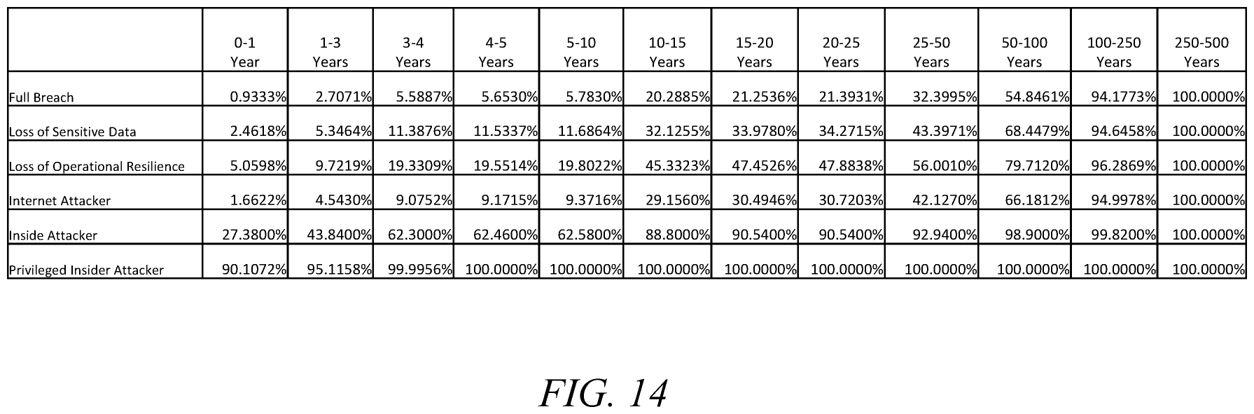

In FIG. 14, the QCDC model shows the raw data of the probability of a breach over time using 500,000 Simulations using full breach, loss of sensitive data, loss of operational resilience, Internet attacker, insider attacker, and privileged insider attacker. As shown in FIG. 14, the different scenarios illustrate the aggregate risk based on types of attacker scenarios with the highest aggregate probability of a breach over time being attributed to a privileged user attack is 90.1%.

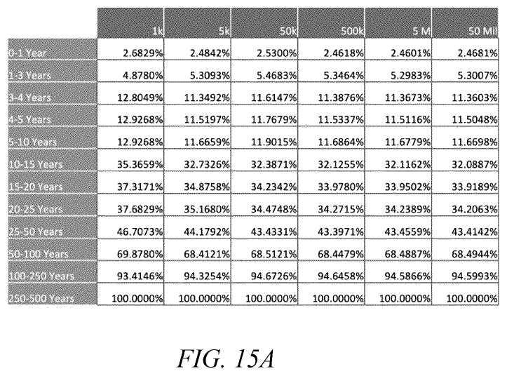

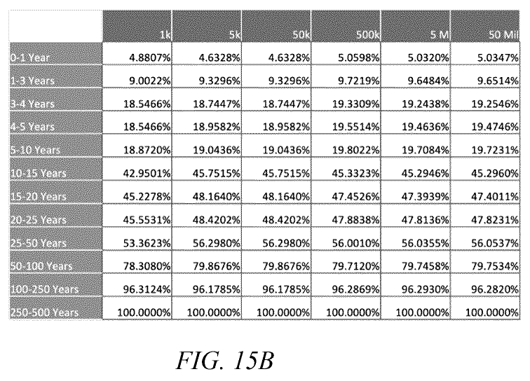

FIGS. 15A and 15B are simulation results for the probabilities of a breach over time for loss of sensitive data and loss of operational resilience, respectively. As expected, the central limit theorem is applied because the large random of random samples, N, from the population of attack paths with replacement resulting in the distribution of the sample means that is normally distributed. The 500,000 k random simulations was the standard used across all models and the difference between 500,000, 5M, and 50M is immaterial to the overall probability.

This disclosure describes a proven quantified cybersecurity risk model that can be leveraged to articulate the cybersecurity risk posture of an organization by communicating the likelihood of breach by expected breach in future years by considering threat actor and group capability, threat actor attack location, and risk & compromise impacts. Additionally, this method allows for better decision-making at the organizational level, mainly focused on the highest risk areas that will produce the maximum risk reduction on investment.

The Novel QCDC model contributions include:
using a digital twin to simulate how attackers can exploit paths and attack vectors to compromise an organization.
natural language processing with clustering to capture a group of similar attackers, like Russian nation-state actors, to understand the likelihood of breach by expected breach in future years and leverage the digital twin model.
applying graph theory to simulate the fastest path of an attack using e.g., Dijkstra's algorithm for the shortest path. As identified in the second novel contribution, a group of attackers could successfully compromise the company.
predicting threat actor attribution to identify which threat actor is attacking a company by leveraging the digital twin network attack paths and controls.

Additionally, the novel contributions of this model are specifically designed to assist in developing an aggregate cybersecurity risk management strategy to protect the organization from attackers. The QCDC model was researched and developed to leverage the novel contributions to focus on how attackers use attack paths and aid in understanding the mitigations that prevent a breach. However, the novel contributions directly impacted the cybersecurity risk articulation models producing significant outcomes for the QCDC risk model.

The present disclosure describes the QCDC model that is based on the digital twin graph theory to develop complex models by leveraging the network to determine the probability of a successful attack by the expected breach in future years, the Cyber Defense & Mitigation Model (CDMM), in which a control model is built that allows for the organization to defend against attackers, and the Cyber Attack Threat Exposure (CATE) model developed to creating the patterns in the digital twin and graph theory analysis.

In summary, this disclosure describes an embodiment of a cybersecurity risk model using a digital twin and graph consisting of attack flows and controls based on real-world observations utilizing a comprehensive catalog of security and privacy controls to produce a probability of a breach by the expected breach in future years risk model. The primary concern for cybersecurity defense is the ability to assess risk and adjust corporate priorities accordingly. A novel cybersecurity risk model was built using a digital twin and graph of attacker attack paths in conjunction with a comprehensive catalog of security and privacy controls. This modeling approach built a robust and complex risk and breach calculator. This approach enables customization in a changing threat landscape and cyber defensive position to provide an organizational-level view of the probability of a breach by the expected breach in future years. The model utilizes graph theory, digital twin, natural language processing, the latest threat intelligence, and actual control mitigations. The QCDC model offers the potential to change decision-making and demonstrate this approach is highly effective, efficient, and very applicable for communicating cybersecurity risk to an organization. This novel approach also aids in developing modeling that can simulate the implementation of a security strategy to determine the maximum risk reduction on investment (MRROI).

A novel approach to build a quantified cybersecurity risk model was leveraged to articulate the cybersecurity risk posture of an organization by stating the probability of breach by expected breach in future years. Additionally, this method allowed for better organizational decision-making mainly focused on the highest risk areas.

Additionally, the model's future is to have the cybersecurity security, development, and data science communities contribute to help build and operationalize the model to pilot the model in large organizations. Additional capabilities that could be included are incorporating real-time threat intelligence, building machine learning models in the Cyber Defense & Mitigation Model (CDMM), and building a Software as a Service (or SaaS) platform.

The features of the present invention which are believed to be novel are set forth below with particularity in the appended claims. However, modifications, variations, and changes to the exemplary embodiments of the artificial intelligence-based quantified cyber defense control model described above will be apparent to those skilled in the art, and the innovations described herein thus encompasses such modifications, variations, and changes and are not limited to the specific embodiments described herein.

What is claimed is:

1. A system to model probability of risk for future cybersecurity breach of a target comprises:
a quantified cyber defense control (QCDC) model configured to receive data associated with cyber controls structure, control type control coverage, control strength, validation frequency, attack paths, threat intelligence, threat actors, attack tactics and techniques, and subject matter expertise control structure;
wherein the QCDC model includes:
a cyber defense & mitigation model (CDMM) configured to determine all available attacks that can be executed against the target by an attacker;
a cyber attack threat exposure model (CATE) configured to model a threat actor's previous attack pathways, current attack pathways, and future attack pathways against the target; and
a digital twin simulation module configured to simulate combinations of possible attack pathways specified in the CATE model;
wherein the QCDC model is configured to describe the problem of cybersecurity breach against the target as a sequence of bipartite directed graphs having a plurality of nodes representing attack techniques and tactics between a source node and a sink node; and
wherein the QCDC model is configured to generate an output indicative of a probability of a breach against the target and associated mitigating defenses.

2. The system of claim 1, wherein the CDMM model is a mapping between controls and attacks used to determine the success probability of an attacker and the target's ability to prevent a successful cyber attack.

3. The system of claim 1, wherein the CDMM model incorporates machine learning techniques to receive and analyze cyber controls structure, control type control coverage, control strength, validation frequency to measure their effectiveness under a cyber attack.

4. The system of claim 1, wherein the CDMM model is an aggregated controls model configured to receive and analyze cyber controls structure, control type control coverage, control strength, validation frequency to develop a probability weighting of a successful cyber attack.

5. The system of claim 1, wherein the CDMM model comprises an aggregated controls model configured to receive and analyze cyber controls structure, control type control coverage, control strength, validation frequency to develop a probability weighting of successfully preventing a cyber attack.

6. The system of claim 1, wherein the CDMM and CATE models are configured to incorporate machine learning, digital twin, and graph theory techniques to receive and analyze cyber controls structure, control type control coverage, control strength, validation frequency to measure their effectiveness under an attack.

7. The system of claim 1, wherein the CATE model is configured to calculate a series of steps in chronological order that an attacker performs to achieve a successful cyber attack of the target.

8. The system of claim 1, wherein the digital twin simulation module is configured to simulate cyber attack paths and path combinations specified in the CATE model of known attack threat actors.

9. The system of claim 1, wherein the digital twin simulation module is configured to simulate attack entry points for attack paths and path combinations specified in the CATE model.

10. The system of claim 1, wherein the digital twin simulation module is configured to simulate and determine at least one of a fastest breach path, a cumulate path, and a most common path of the threat actor's cyber attack specified in the CATE model.

11. The system of claim 1, wherein the CATE model incorporates natural language processing to identify and group attackers using similar attack methodologies.

12. The system of claim 1, wherein the QCDC model is configured to incorporate machine learning and graph path analysis to generate an output indicative of most likely attack methodologies and most effective associated mitigating defenses.

13. The system of claim 1, wherein the bipartite directed graph includes a plurality of nodes representing attack techniques and tactics from the CATE model and weights for the nodes are from the CDMM model.

14. A method to model probability of risk for future cybersecurity breach of a target comprises:
receiving data selected from the group consisting of data associated with: cyber controls structure, control coverage, control strength, validation frequency, attack paths, threat intelligence, threat actors, attack tactics and techniques, and subject matter expertise control structure;
describing the problem of cybersecurity breach against the target as a sequence of bipartite directed graphs having a plurality of nodes representing attack techniques and tactics between a source node and a sink node;
determining all available attacks that can be executed against the target by an attacker;
modeling a threat actor's previous attack pathways, current attack pathways, and future attack pathways against the target;
simulating different possible attack pathway combinations;
determining most likely attacks against the target and mitigating defenses;
generating an output indicative of a probability of a breach over time in years against the target.

15. The method of claim 14, further comprising generating a mapping between controls and attacks to determine the success probability of an attacker and the target's ability to prevent a successful cyber attack.

16. The method of claim 14, further comprising incorporating machine learning techniques to receive and analyze cyber controls structure, control type control coverage, control strength, validation frequency to measure their effectiveness under a cyber attack.

17. The method of claim 14, further comprising using an aggregated controls model to receive and analyze cyber controls structure, control type control coverage, control strength, validation frequency to develop a probability weighting of a successful cyber attack.

18. The method of claim 14, further comprising using an aggregated controls model to receive and analyze cyber controls structure, control type control coverage, control strength, validation frequency to develop a probability weighting of successfully preventing a cyber attack.

19. The method of claim 14, further comprising incorporating machine learning, digital twin, and graph theory techniques to receive and analyze cyber controls structure, control type control coverage, control strength, validation frequency to measure their effectiveness under an attack.

20. The method of claim 14, further comprising calculating a series of steps in chronological order that an attacker performs to achieve a successful cyber attack of the target.

21. The method of claim 14, further comprising simulating cyber attack paths, path combinations, and entry points from known attack pathways and known attack threat actors specified in a cyber attack threat exposure model (CATE).

22. The method of claim 14, further comprising simulating and determining at least one of a fastest breach path, a cumulate path, and a most common path of the threat actor's cyber attack specified in a cyber attack threat exposure model (CATE).

23. The method of claim 14, further comprising incorporating natural language processing to identify and group attackers using similar attack methodologies.

24. The method of claim 14, further comprising incorporating machine learning and graph path analysis to generate an output indicative of most likely attack methodologies and most effective associated mitigating defenses.

25. The method of claim 14, further comprising incorporating the bipartite directed graphs includes a plurality of nodes representing attack techniques and tactics from a cyber attack threat exposure model (CATE) and weights for the nodes are from a cyber defense & mitigation model (CDMM).
